(19) United States
(12) Patent Application Publication
(10) Pub. No.: US 2005/0138856 A1
(43) Pub. Date: Jun. 30, 2005

(54) Fishing rod holder for ice fishing

(76) Inventor: Val A. J. Hansen, Ignace (CA)

Correspondence Address: ADE & COMPANY, 1700-360 MAIN STREET, WINNIPEG, MB, R3C3Z3, CA

(21) Appl. No.: 10/965,235

(22) Filed: Oct. 15, 2004

(30) Foreign Application Priority Data
Nov. 24, 2003 (CA) 2,450,505

(51) Int. Cl. A01K 97/10; A01K 97/01

(52) U.S. Cl. 43/21.2

(57) ABSTRACT

A fishing rod holder for use with an ice fishing hole is formed by a planar hoop member shaped and arranged to surround the hole for resting on the ice surface around the hole having at one location on its periphery an indented portion forming a bight arranged to extend partly across the hoop toward an opposite part of its periphery such that an apex of the bight is located approximately at a midpoint of the hoop for location at the centre of the hole. A sleeve with a pinched bottom end is located on the hoop member by wrapping of the bottom end around one peripheral portion of the hoop to allow rotation of the sleeve about the portion and location of the sleeve at an angle upwardly and inwardly for receiving the butt end of a fishing rod in an operating position inclined upwardly and inwardly of the hoop member.

This invention relates to a fishing rod holder for ice fishing which properly locates the fishing rod at an ice fishing hole and also guides the fishing line.

Many different designs are available for holding a rod at an ice fishing hole but there remains opportunity for a simply inexpensive device which properly locates to rod and the line for most effective operation.

### SUMMARY OF THE INVENTION

According to the invention there is provided a fishing rod holder for use with an ice fishing hole comprising:
a planar hoop shaped and arranged to surround the hole for resting on the ice surface around the hole;
the hoop having at one location on its periphery an indented portion forming a bight arranged to extend partly across the hoop toward an opposite part of its periphery such as an apex of the bight is located approximately at a midpoint of the hoop for location at the centre of the hole;
and a sleeve arranged to be located on the hoop member for receiving the butt end of a fishing rod in an operating position inclined upwardly and inwardly of the hoop member.

The hoop member bay be formed of a metal hoop bent to form in indent, which hoop is open in the middle or may be formed of a generally planar body such as a plastics material with an integral cover where the bight is formed by indenting a part of the periphery to a central opening to locate the line.

Preferably the sleeve is attached by a hinge connecting the sleeve to the hoop for rotation around an axis extending along the hoop from the operating position inclined upwardly and inwardly of the hoop to a folded position co-planar with the hoop.

Alternatively the sleeve may be clipped into place on the hoop member either of the metal hoop type or of the molded plastics type.

Preferably the hinge connection includes an abutment between the sleeve and the hoop for locating the operating position of the sleeve.

Preferably the abutment is manually adjustable to vary the angle of the fishing rod relative to the hoop so as to position the upper end of the fishing rod relative to the centre of the hoop.

Preferably the sleeve is formed from a tube which is pinched at the lower end to form a flattened section with the flattened section rolled to form a collar surrounding a portion of the hoop.

Preferably the hinge is located on the hoop at a portion on the periphery opposite the indented portion.

Preferably, where the hoop member does not include an integral cover there may be provided for the hoop a cover member formed of a sheet material for attachment to the hoop.

Preferably the cover has a peripheral shape matching that of the hoop.

Preferably the cover includes a tab portion arranged for fastening around the sleeve.

Preferably the cover includes a slot for location at a position aligned with the bight extending from the peripheral edge to the center of the cover.

Preferably the cover is formed from a foam material.

### DESCRIPTION OF THE DRAWINGS

One embodiment of the invention will now be described in conjunction with the accompanying drawings in which:

FIG. 1 is an isometric view of a fishing rod holder according to the present invention.

FIG. 2 is a top plan view of the fishing rod holder of FIG. 1.

FIG. 3 is a cross sectional view along a centre line of the holder of FIG. 1.

FIG. 4 is a plan view on an enlarged scale of one portion of the periphery of the holder of FIG. 1 showing the hinge.

FIG. 5 is a side elevational view showing movement of the holder from the operating position to the folded position.

FIG. 6 is a top plan view of an optional cover.

### In the drawings like characters of reference indicate corresponding parts in the different figures.

### DETAILED DESCRIPTION

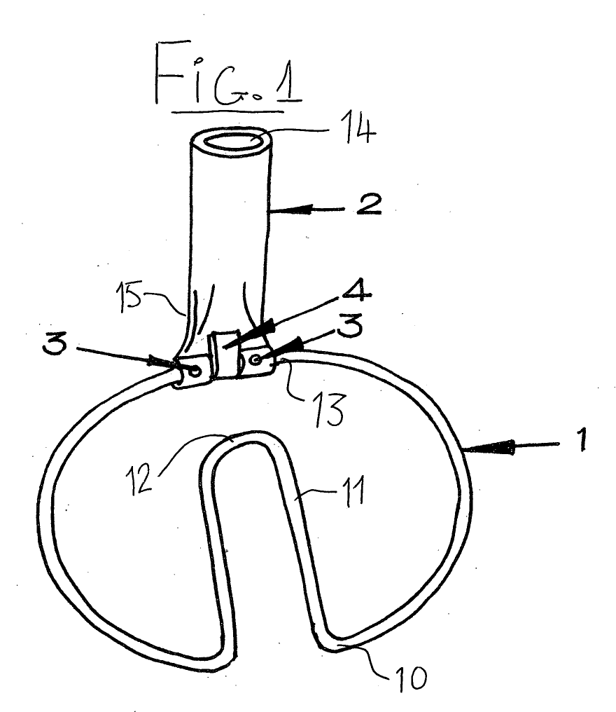

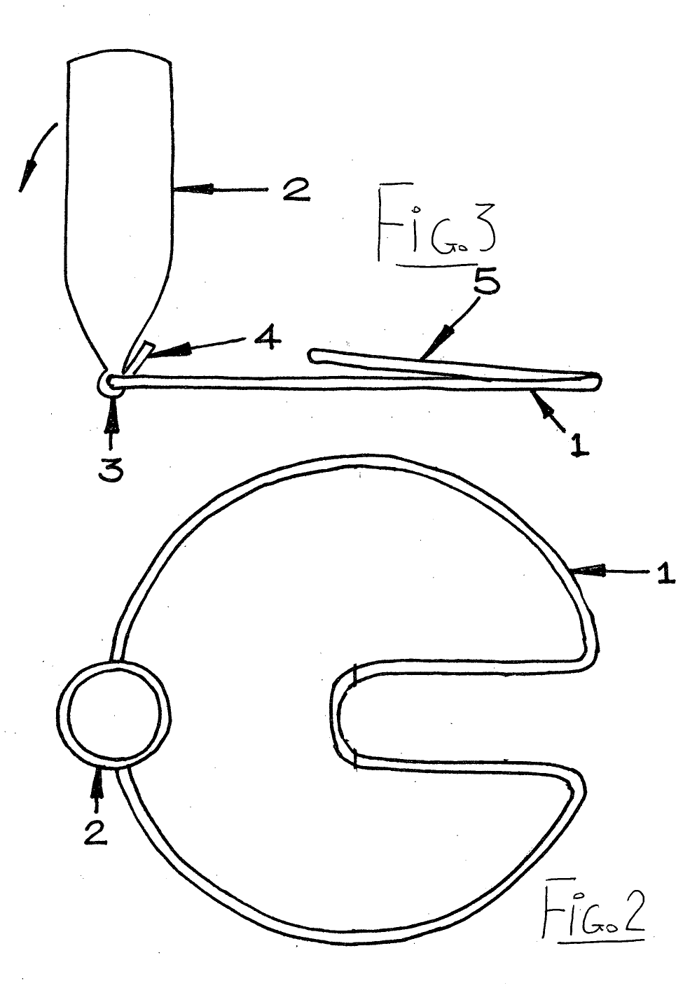

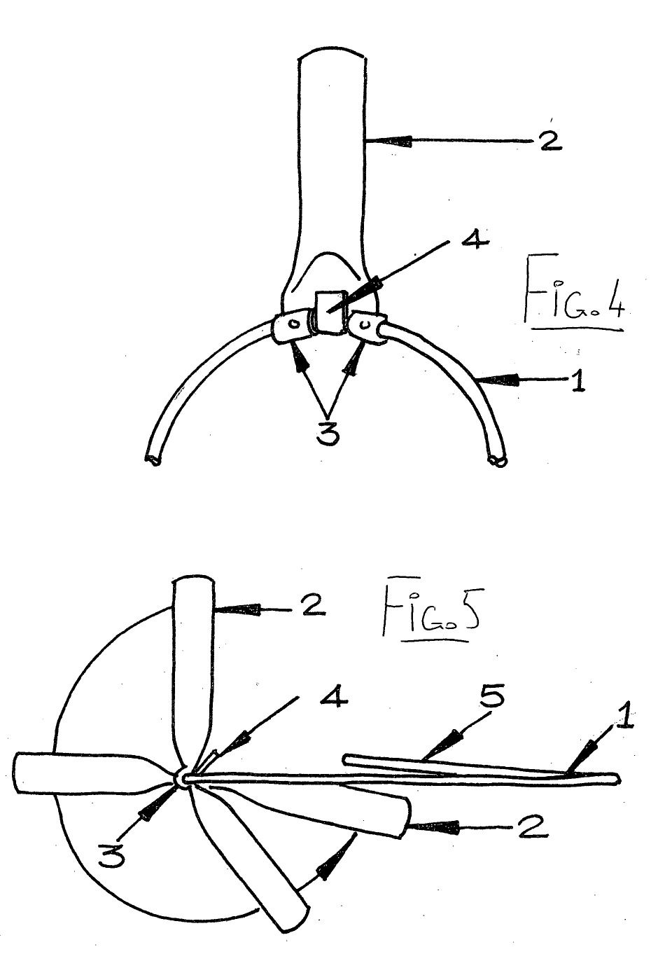

In FIG. 1 is shown a hoop 1 which is planar so as to lie flat on the ice surface when located on the ice surface surrounding a hole in the ice for ice fishing. The hoop is shown as being circular in plan but can be of other shape if required including square. The requirement is that the hoop be of a sufficient size and shape so as to surround the ice fishing hole and rest securely on the ice surface leaving the hole open and exposed within the outer periphery of the hoop. At one location 10 on the periphery is formed a bight 11 which projects inwardly into the centre area of the hoop in the common plane with the hoop to form an apex 12 of the bight located approximately at the centre of the hoop.

The hoop is continuous around the periphery so as to form a rigid structure. The hoop is preferably formed of a suitable metal rod bent to shape and welded to complete the continuous periphery. At a position 13 on the hoop which is generally opposite to the location 10 of the bight is provided a sleeve 2 with an open upper end 14 for receiving the butt end of a fishing rod. The sleeve is formed of a tube which is pinched at its lower end to form a flattened section 15. The flattened section 15 is rolled to form collars 3 defining a hinge shaped and arranged to surround to hoop at the portion 13. In between the two collars 3 is provided an abutment 4 which is welded onto the flattened section of the tube.

The sleeve 2 and its hinge 3 are conveniently formed from a flattened tube in this manner but other techniques for manufacturing the sleeve can be provided and the sleeve does not need to be continuous provided it defines a receptacle for a lower or butt end of the fishing rod to support the fishing rod standing upwardly from the sleeve along the axis of the sleeve.

The abutment 4 is adjustable in its position relative to the hoop so as to located the sleeve in an operating position a shown in FIG. 1 where the sleeve is inclined upwardly and inwardly to locate the upper end of the fishing rod directly above the apex of the bight so that the fishing line can depend from the upper end through the apex of the bight into the hole.

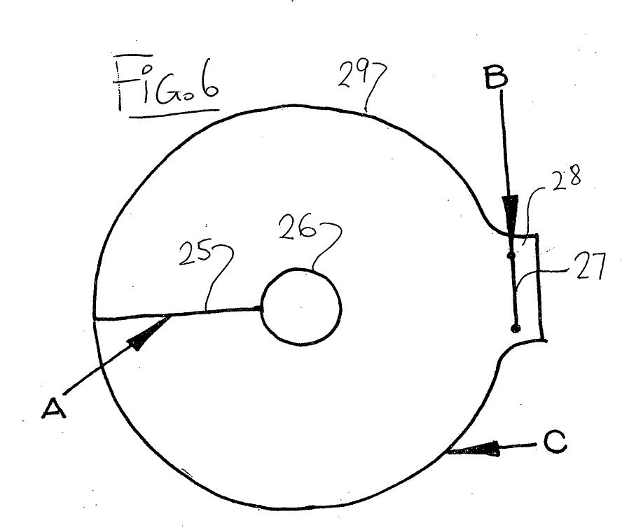

The sleeve can also be rotated around the hinge defined by the axis along the hoop into a folded position by rotation in a counter clockwise direction as shown in FIG. 5 to a position where it is co-planar with the hoop for storage or transportation.

As the fishing line extends through the bight rather than through the interior of the hoop, the rod holder and the lower end of the rod can be moved away from the hole simply by pulling the rod holder in the direction of the portion 13 thus pulling the bight away from the fishing line. This allows the user to move the rod holder away from the hole when landing a fish. The bight locates the fishing line and prevents it from engaging the side of the hole where it may freeze to the edge of the hole during winding days. The rod holder provides no interference with the rod, line fish when clearing away the rod holder. The rod holder fits over six inch, eight inch or ten inch drilled holes through the ice since the outside periphery is greater than these dimensions. The rod is preferably a quarter inch steel ring with the sleeve being a one and a half inch steel tube. The stop 4 is attached to the ring or hoop so that it locates the lower end of the sleeve when pivoted to the required angle.

As shown in FIG. 6 there is provided an optional cover which is formed from a thin sheet of foam material of the order of ¼ inch thickness which is shaped and arranged to fit over the loop and to be fastened thereto in a manner such that it spans the loop. The cover includes a slot 25 cut through to a centre hole 26 from the edge of the cover so that the slot can be located directly over the bight allowing the fishing line to slide into the centre circle at the apex of the bight. The cover is held in place by another slot 27 which is arranged in a projecting tab piece 28 extending outwardly from the circular outer edge 29. The tab piece fits over the sleeve 20 and the slot 28 which is parallel to the edge 29 at the tab piece allows the sleeve to slide through the slot. Thus the cover is held in place at the sleeve and has sufficient stiffness to remain in place over the loop. Additional fastening tabs at spaced positions around the edge 29 may be provided for greater stability.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A fishing rod holder for use with an ice fishing hole comprising:
a planar hoop member shaped and arranged to surround the hole for resting on the ice surface around the hole;
the hoop member having at one location on its periphery an indented portion forming a bight arranged to extend partly across the hoop toward an opposite part of its periphery such as an apex of the bight is located approximately at a midpoint of the hoop for location at the centre of the hole;
and a sleeve arranged to be located on the hoop member for receiving the butt end of a fishing rod in an operating position inclined upwardly and inwardly of the hoop member.

2. The fishing rod holder according to claim 1 wherein the sleeve is attached by a hinge connecting the sleeve to the hoop for rotation around an axis extending along the hoop from the operating position inclined upwardly and inwardly of the hoop to a folded position co-planar with the hoop.

3. The fishing rod holder according to claim 2 wherein the hinge connection includes an abutment between the sleeve and the hoop for locating the operating position of the sleeve.

4. The fishing rod holder according to claim 3 wherein the abutment is manually adjustable to vary the angle of the fishing rod relative to the hoop so as to position the upper end of the fishing rod relative to the centre of the hoop.

5. The fishing rod holder according to claim 1 wherein the sleeve is formed from a tube which is pinched at the lower end to form a flattened section with the flattened section rolled to form a collar surrounding a portion of the hoop.

6. The fishing rod holder according to claim 1 wherein the sleeve is located on the hoop at a portion on the periphery opposite the indented portion.

7. The fishing rod holder according to claim 1 wherein there is provided a cover member formed of a sheet material for attachment to the hoop.

8. The fishing rod holder according to claim 7 wherein the cover has a peripheral shape matching that of the hoop.

9. The fishing rod holder according to claim 7 wherein the cover includes a tab portion arranged for fastening around the sleeve.

10. The fishing rod holder according to claim 7 wherein the cover includes a slot for location at a position aligned with the bight extending from the peripheral edge to the center of the cover.

11. The fishing rod holder according to claim 7 wherein the cover is formed from a foam material.
